(19) United States
(12) Patent Application Publication
(10) Pub. No.: US 2013/0224350 A1
(43) Pub. Date: Aug. 29, 2013

(54) CUPCAKE SECRET

(71) Applicant: Global Concepts Limited, Inc., dba Global TV Concepts Ltd., (US)

(72) Inventor: Laurie Braden, Boca Raton, FL (US)

(73) Assignee: Global Concepts Limited, Inc., dba Global TV Concepts Ltd., Deerfield Beach, FL (US)

(21) Appl. No.: 13/857,486

(22) Filed: Apr. 5, 2013

Related U.S. Application Data
(62) Division of application No. 13/358,171, filed on Jan. 25, 2012.
(60) Provisional application No. 61/585,410, filed on Jan. 11, 2012.

(51) Int. Cl. A21D 8/06; A47J 27/00

(52) U.S. Cl. CPC A21D 8/06; A47J 27/002
USPC 426/280

(57) ABSTRACT

A baking apparatus and method is disclosed that includes at least one baking cup configured to receive a first product and an interior baking, structure configured to suspend a second product within the first product. The interior baking structure may be a peg to suspend an item during baking, or a hollowing structure configured to create a hollow portion in the first product. The bottom of the baking cup may also include an aperture, which is removably covered while baking. A riser may also be provided configured to expel baked products from the pan by lining the riser up with the aperture to push the products out of the pan.

### BACKGROUND

The present disclosure relates to a baking apparatus and method. In particular, the present disclosure relates to an apparatus and method for baking products, such as cupcakes, pies and the like.

Cupcakes and pies are common food items sold in stores and made at home. Often, cupcakes, pies and the like may include various fillings such as fruit, cookie dough, frosting, whipped cream and the like. However, providing cupcakes and pies with filling can be challenging. For example, it can be difficult to provide the desired filling at the desired location within the cupcake or pie. Moreover, adding the filling after baking prolongs the manufacturing process and food is also wasted as the cupcake or pie may need to be hollowed to place filling inside.

It is also challenging to remove the cupcake or pie from the baking pan. If the pan is inverted, the cupcake or pie may fall out and lose shape, topping or filling. If the cupcake or pie is removed with a knife or similar object, the cupcake or pie shape or filling may be compromised.

### SUMMARY

In view of the challenges involved with current baking devices and methods, there exists a need to provide an apparatus and method for easily baking cupcakes, pies and the like with a filling, and also removing baked products from a pan.

In one example, a baking pan includes a main support structure and at least one baking cup disposed within the main support structure. The baking cup includes a sidewall and a bottom and is configured to receive a first product, for example, cupcake mix. The main support structure may further include a top surface and a steam cup disposed within the top surface to help moisten the product while baking.

The baking pan may also include an interior baking structure configured to suspend a second product within the first product. This interior baking structure may be a peg to suspend an item during baking, for example, a piece of chocolate within the baking mix. Alternatively, the interior baking structure may be a hollowing structure configured to create a hollow portion in the first product. For example, a tube with an empty top may be suspended within the cake mix to allow the product to bake with a hole, which is filled after baking with, for example, cold whipped cream.

The bottom of the baking cup may also include an aperture in its bottom, which is removably covered while baking. A riser may also be provided configured to expel baked products from the pan by lining the riser up with the aperture to push the products out of the pan.

Further scope of applicability of the present disclosure will become apparent from the detailed description given hereinafter and the accompanying drawings which are given by way of illustration only, and thus not to be considered limiting.

### BRIEF DESCRIPTION OF THE DRAWINGS

FIG. 1 shows an exemplary embodiment of a baking pan that includes a peg and a hollowing structure;

FIG. 2 shows an exemplary embodiment of an interior baking structure that includes a peg, a pin, a block and a base;

FIG. 3 shows an exemplary embodiment of an interior baking structure that includes a base, a peg and a hollowing structure;

FIG. 4 shows an exemplary embodiment of a baking pan that includes apertures in the bottom of the baking cups; and

FIG. 5 shows an exemplary embodiment of a riser.

### DETAILED DESCRIPTION

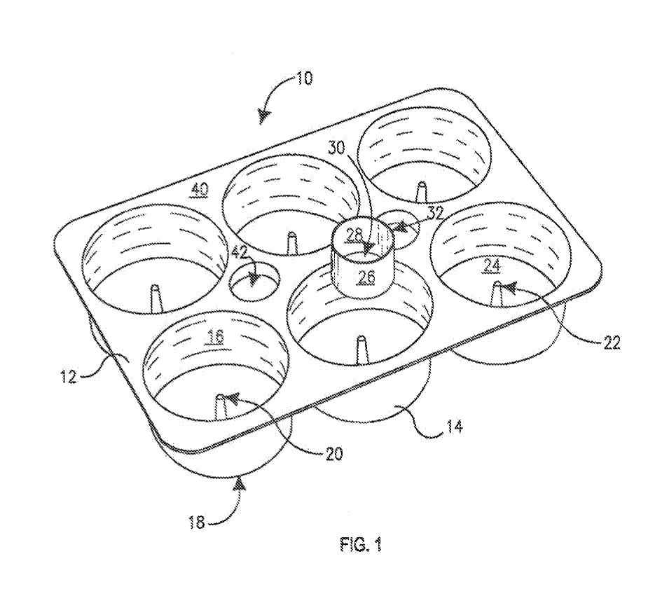

In the drawings, wherein like numerals indicate like elements, there is shown various exemplary embodiments of a baking apparatus. Referring to FIG. 1, a baking pan 10 includes a main support structure 12, and at least one baking cup 14 disposed within the main support structure 12, The baking cup 14 includes a sidewall 16 and a bottom 18. The baking cup 14 is configured to receive a first product, for example, a cupcake mix. The baking cup 14 may be of any desired size and/or configuratiom. For example, in FIG. 1, the baking cup 14 is generally cylindrical in configuration. In addition, while six (6) baking cups 14 are illustrated in FIG. 1, it should he understood that any desired number of baking cups 14 may be provided.

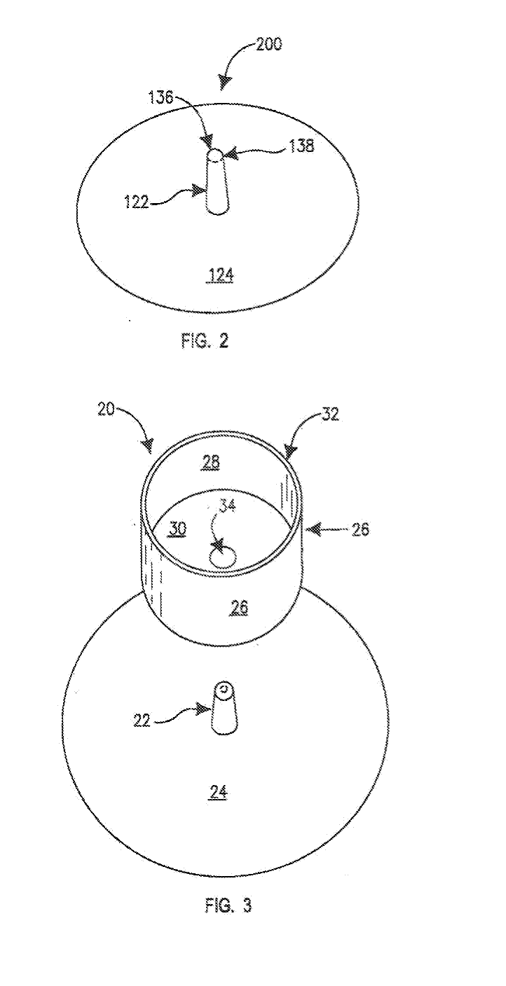

The baking pan 10 may also include an interior baking structure. One exemplary embodiment of an interior baking structure is illustrated in FIGS. 1 and 3 at number 20, while another exemplary embodiment of an interior baking structure is illustrated in FIG. 2 at number 200. The interior baking structure may be configured to create a cavity within the first product, and into which a second product may be provided, and/or to suspend a second product within the first product, for example, an object used as a filling. The interior baking structure can have various configurations. The interior baking structure may also allow for the second product to be placed in various locations within the baking cup 14. For example, the interior baking structure may be configured so as to place the second product in the vicinity of the upper half of the baking cup 14, and at a location to allow the first product to substantially surround the second product, as described in more detail herein. As should be understood, however, the interior baking structure may operate to place the second product at any desired location.

For example and referring to FIG. 2, the embodiment of the interior baking structure 200 may include a peg 122, a pin 136, a block 138 including an aperture sized to receive the pin, and a base 124 shaped to fit within the at least one baking cup 14. This configuration allows for the placement of the second product upon the pin 136 and/or peg 122, in order for the second product to be used as a filling during baking. The components of the interior baking structure 200 may be of any desired size or configuration. For example, in the current illustration, the peg 122 is generally elongated and cylindrical in shape, and the block 138 and base 124 are both circular in shape (with the diameter of block 138 being less than that of the base 124). The interior baking structure 200 is also removable in the current illustration from the at least one baking cup 14, although in other variations this may be a fixed structure.

Another embodiment of the interior baking structure is shown in FIG. 3. The interior baking, structure 20 in FIG. 3 includes a peg 22 and a base 24 along with an interior hollowing structure 26 configured to create a hollow cavity portion in the first product. Although not shown, a pin similar to the pin 138 may he provided, and located at the top of the peg 22. The interior hollowing structure 26 may be of any desired size or configuration, which in the present illustration includes a sidewall 28, a base 30 and an open top 32. In the present embodiment, the interior hollowing structure 26 is generally cylindrical in configuration. The interior hollowing structure 26 may farther include an aperture 34, which is generally circular in the present example, although it should be understood that other shapes may he provided. The aperture 34 is sized in the present embodiment to receive a portion of the peg 22. For example, the generally cylindrical shaped peg 22 may be received into the circular shaped aperture 22. The interior hollowing structure 26 is removable from the at least one baking cup 14 in the present example.

Although not shown, the interior hollowing structure 26 may also be utilized with the interior baking structure 200 in FIG. 2. For example, the block 138 may be utilized where desired for safety to protect users from the pin 136. The block 138 may also be utilized where desired as a base for the interior hollowing structure 26. As such, the interior hollowing structure 26 may rest on the block 138 instead of the peg 122.

Referring to the interior baking structure 20 in FIG. 3, during an exemplary baking process, the first product (i.e., batter) may be place or poured within the at least one baking cup 14 and filled to a level in order to surround a portion of or the entirety of the interior hollowing structure 26. The first product may then be baked so that the finished product is included with a hollow cavity portion, and which would allow for a second product to be added within the hollow portion either during or after baking.

In other examples not shown, the interior hollowing structure 26 may also be used without the peg 22 and/or the base 24 to create a hollow portion in the first product. In the illustrated embodiment, the at least one baking cup 14 may be filled with the first product and the interior hollowing structure 26 placed within the first product allowing the first product to bake with a hollow cavity. This allows for a second product to be added within the hollow portion either during and/or after baking.

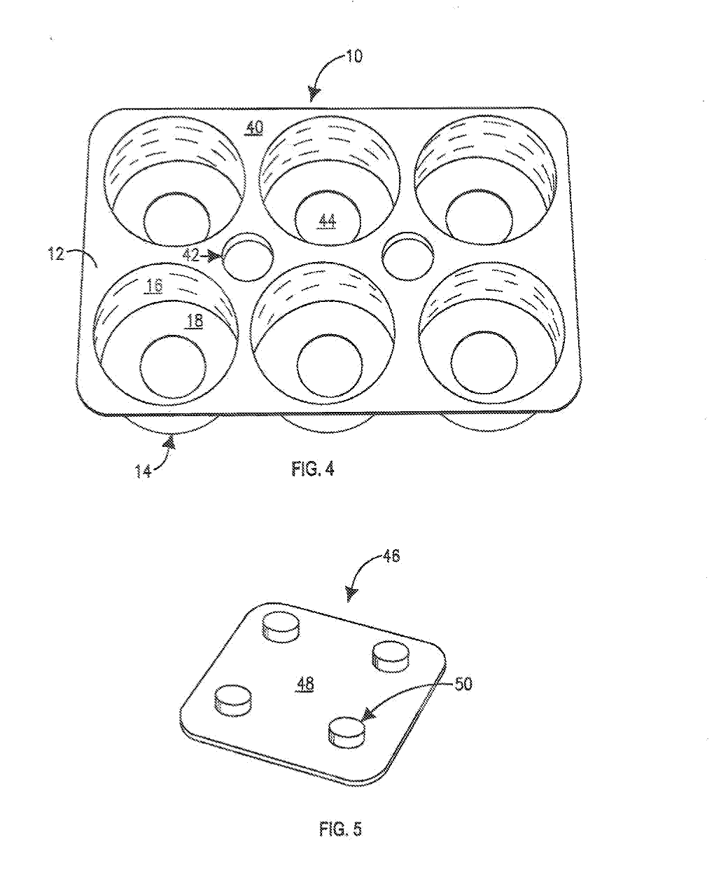

Now referring to FIGS. 1 and 4, the main support structure 12 may further include a top surface 40 and at least one steam cup 42 disposed within the top surface. In the current example, the steam cup 42 is generally cylindrical in shape, although any other desired shapes may also be utilized, and there are two (2) steam cups 42. The steam cup 42 allows for the addition of a liquid, for example water, during the baking process to moisten the first and/or second product during baking.

Referring now to FIGS. 4-5, the bottom 18 of the baking cup 14 may include an aperture 44, which is generally circular in configuration, although it should be understood that an desired shape or size for aperture 44 may be utilized. For example, the aperture 44 may facilitate removal of the interior baking structure 20 from the at least one baking cup 14 after a product has been baked, for example, by allowing a user to push the interior baking structure 20 with his or her finger. The baking pan 10 may further include an optional riser 4 configured to expel the baked product from the baking cup 14. The riser 46 includes a riser main support structure 48 and a bump 50. The bump 50 is cylindrical in shape in this example, although may be of any desired size or configuration. When baking, the aperture 44 is covered by for example, the base 24 of the interior baking structure 20. After baking, the bump 50 of the riser 46 may be aligned and inserted into the aperture 44 to expel the products.

The baking pan 10 may be used to bake any food product, including but not limited to cupcakes and pies. As such, the baking cup 14 may be different shapes to accommodate cupcakes, pies or other products. The baking cup 14 may also be configured into a decorative shape. The baking pan 10 may be made of any suitable materials, including, but not limited to, steel, aluminum, tin, silicone and the like. Pliable materials such as silicone may facilitate the removal of a baked product from the baking pan 10 and/or any one of its components.

Turning now to the methods of baking, a baking pan may be provided that encompasses any of the above embodiments. With the interior baking structure 200 that includes the peg 22, pin 36, block 38 and base 24 configuration, a second product may be placed on the peg 22, or the pin 36 inserted into the second product to help retain the second product in position. The second product, for example, chocolate, may be suspended or otherwise positioned by the peg 22, or the pin 36, within the at least one baking cup 14. Then, the first product (i.e. batter) may be placed within the at least one baking cup 14 and filled to any desired level, such as to surround the second product. The baking pan 10 can then be heated, for example in an oven, for baking.

In addition, in situations where the interior hollowing structure 26 would also be utilized, the interior hollowing structure 26 may be placed upon the block 38 either before or after adding the first product to the at least one baking cup 14. Then, the first product may be added if not done so, and the first product may be baked. After baking, the interior hollowing structure 26 may be removed thereby leaving a hollow portion in the first product. The hollow portion may be filled with a second product. Alternatively, the interior hollowing structure 26 may be filled with a second product during baking so that the second product bakes concurrently with the first product, but stays apart from the first product.

In situations where the interior hollowing structure 26 may also include the Aperture 34, the aperture 34 may receive a portion of the peg 22, such that the interior hollowing structure 26 is seated on the peg 22. The first product may then be added to surround the peg 22 and interior hollowing structure 26 thereby creating a hollow portion in the first product. After baking, the interior hollowing structure 26 may be removed thereby leaving a hollow portion. The hollow portion may be filled with a second product. Alternatively, the interior hollowing structure 26 may be filled with a second product during baking so that the second product bakes concurrently with the first product, but stays apart from the first product. Further, the peg 22 and interior hollowing structure 26 ma be one integral piece where desired.

As noted above, the bottom 14 of the baking pan 10 and the baking cup 14 may include an aperture 44. A riser 46 may also be provided and configured to expel the first and second product from the baking cup 14. The riser 46 includes a riser main support structure 48 and a bump 50. This method is done by baking the product or products and then placing the riser 46 underneath the baking pan 10 such that the bump 50 on the riser 46 is aligned with the aperture 44 on the bottom 14 of the baking cup 14. Then, the riser 46 and baking pan 10 are brought together thereby expelling the first product from the baking pan 10. Normally, the aperture 44 would be separated from the product by an interior baking structure 20, such as for example, the base 20 of an interior baking structure 20. Then, the bump 50 would contact the base 20 and push substantially the entire bottom of the baked first product up out of the baking cup 14.

As discussed above and shown in FIGS.. 1 and 4, the main support structure 12 of the baking pan 10 may include a top surface 40 and at least one steam cup 42 disposed within the top surface 40. The method of baking includes pouring liquid into the steam cup 42 prior to heating the baking pan 10. This liquid will evaporate during heating thereby moistening the products in the baking pan 10.

The foregoing examples are provided merely for the purpose of explanation and are in no way to be construed as limiting. While reference to various embodiments is shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

1. A method of baking, comprising:
providing a baking pan comprising:
a main support structure;
at least one baking cup disposed within the main support structure, the baking cup comprising a sidewall and a: bottom, the baking cup configured to receive a first product; and
an interior baking structure configured to suspend a second product within the first product.

2. The method of claim 1, further comprising:
placing the second product upon the interior baking structure;
placing the first product within the at least one baking cup thereby surrounding the second product; and
heating the baking pan.

3. The method of claim l, wherein the interior baking structure comprises an interior hollowing structure configured to create a hollow portion in the first product, and the method further comprises:
placing the first product within the at least one baking cup;
placing the interior hollowing structure within the first product;
heating the baking pan;
removing the interior hollowing structure from the first product; and
placing a second product within the hollow portion in the first product.

4. The method of claim 1, wherein the bottom of the baking cup comprises an aperture, and the method further comprises providing a riser sized to be received in the aperture, and placing the riser underneath the baking pan such that the riser is aligned with the aperture on the bottom of the baking cup, and bringing the riser and baking pan together thereby expelling the first product from the baking pan.

5. The method of claim 1, wherein the main support structure further comprises a top surface and at least one steam cup disposed within the top surface, and the method further comprises pouring liquid into the steam cup.

6. A method of baking, comprising:
providing a baking pan comprising:
a main support structure;
at least one baking cup disposed within the main support structure,
the baking cup comprising a sidewall, a bottom, and an aperture in the bottom; and
a base configured to fit within the at least one baking cup;
positioning, the base within the at least one baking cup so that the base engages the bottom of the at least one baking cup and covers the aperture in the bottom of the at least one baking cup;
placing a product within the at least one baking cup; and
heating, the baking pan to bake the product.

7. The method of claim 6, wherein the sidewall of the at least one baking cup defines an upper end and a lower end, and me bottom of the at least one baking cup is attached to the lower end of the sidewall, and with the bottom of the at least one baking cup being further defined by an upper surface and a lower surface, wherein the base is defined by an upper surface and a lower surface, and the base is positioned with the lower surface of the base being in engagement with the upper surface of the bottom of the at least one baking cup, the method further comprising:
exerting a force upon the lower surface of the base in order move the base from engagement with the bottom of the at least one baking cup and in a direction of the upper end of the sidewall in order to expel the baked product from the at least one baking cup.

8. The method of claim 7, further comprising providing a riser sized to be received in the aperture, and placing the riser underneath the baking pan such that the riser is aligned with the aperture on the bottom of the baking cup, and bringing the riser and baking an together so that the riser contacts the tower surface of the base and moves the base in a direction of the upper end of the sidewall thereby expelling the product from the at least one baking cup.

9. The method of claim 8, wherein the riser comprises at least one of a finger of a user or a separate component.

10. The method of claim 8, further comprising providing a baking pan comprising a plurality of baking cups.
